(19) United States
(12) Patent Application Publication
(10) Pub. No.: US 2011/0176648 A1
(43) Pub. Date: Jul. 21, 2011

(54) PORTABLE LOW ENERGY NEUTRON SOURCE FOR HIGH SENSITIVITY MATERIAL CHARACTERIZATION

(76) Inventors: Mark S. Rowland, Alamo, CA (US); Wolfgang Stoeffi, Livermore, CA (US); Robert Wray Hamm, Pleasanton, CA (US)

(21) Appl. No.: 12/976,216

(22) Filed: Dec. 22, 2010

Related U.S. Application Data
(63) Continuation-in-part of application No. 11/248,377, filed on Oct. 11, 2005, now abandoned.
(60) Provisional application No. 60/617,526, filed on Oct. 8, 2004.

(51) Int. Cl. G21G 4/02; G21G 1/10

(52) U.S. Cl. 376/114; 376/194

(57) ABSTRACT

A portable neutron generator includes a Radio Frequency Quadrupole linear accelerator designed to accelerate charged particles of hydrogen (protons) to energies useful for producing neutrons with the (p,n) reaction on lithium. The ion source is driven by a coaxial feed and a spiral antenna to couple the microwave power into the plasma. The linear accelerator is driven by a 600 MHz pulsed RF power supply. A differential pumping scheme is used to balance the need for a high gas load on the ion source end and good vacuum on the accelerator end.

### CROSS-REFERENCE TO RELATED APPLICATIONS

This application is a continuation-in-part of U.S. application Ser. No. 11/248,377, filed Oct. 11, 2005, which claims the benefit of U.S. Provisional Application No. 60/617,526, filed Oct. 8, 2004, both of which are incorporated herein by reference.

### STATEMENT REGARDING FEDERALLY SPONSORED RESEARCH

The United States Government has rights in this invention pursuant to Contract No. DE-AC52-07NA27344 between the United States Department of Energy and Lawrence Livermore National Security, LLC.

### FIELD

The present invention relates generally to techniques for characterization of nuclear material, and more specifically to neutron generators for use in assaying nuclear material.

### BACKGROUND

Neutrons are a fundamental part of any process involving nuclear fission, and thus detection of neutrons is important for radiation protection purposes and detection of potentially radioactive materials. Neutron sources have long been used for the purposes of material characterization, and much of this work is carried out with low energy neutrons having energies in the range of single electron-volts (eV) to tens of thousands of electron-volts (keV), as most materials have large nuclear cross sections at these energies. Thus, with respect to the generation of neutrons for material characterization, it is desirable that there be no fast neutrons in the emitted beam so that a unique signal can be generated for the presence of fission. Since a nuisance background of fast neutrons is always present with a source of fast neutrons, it is desirable that the all the neutrons given off directly by the source be at low energy.

Neutrons generally provide an ideal complement to photon-based material characterization techniques. Typically, neutrons induce a plethora of signatures that may be sorted categorically and/or quantitatively to perform material characterization. The use of low energy neutrons simplifies signature sorting, and therefore provides insights into the composition and amounts of material that may be present in a sample. In particular, low energy neutrons do not usually produce inelastic reactions and are below many of the thresholds for other types of reactions (e.g., induced fission or n-2n reactions). The existence of these threshold values simplifies the analysis process in some special material cases, as they allow for a test based simply on the existence of some reaction (i.e., a yes or no test), instead of relying on the ambiguous process of quantifying increases in a ubiquitous signal.

Long-lived isotopic neutron sources typically emit high-energy neutrons, and traditional sources of neutrons are often large pieces of equipment, such as reactors and particle accelerators. Low energy neutrons are extremely short lived and difficult to generate, thus low energy neutron sources tend to be very large and expensive, such as accelerator systems that are only located at laboratory sites. For certain material characterization objectives, such as the presence of fissionable material at border checkpoints, it is highly desirable to have a portable source of low energy neutrons that can be easily transported to field sites and quickly set up and operated. However, present small, portable neutron sources, like isotopic neutron emitters and sealed tube neutron generators produce do not produce low-energy neutrons. Instead, present known small neutron sources produce neutrons in the mega-electron-volt (MeV) range. Moreover, these sources generate electrons that project in all directions relative to the source and require large hydrogenous moderators surrounding them to produce the low energy neutrons by collisions with the moderator hydrogen atoms, as well as to act as a shield for personnel.

As stated above, and as described by Kononov et al., by use of the nuclear reaction Li(p,n), it is possible to generate a beam of neutrons, as opposed to a dispersed distribution of neutrons from a source. However, present electric proton accelerators are all very large pieces of equipment, such as on the order of tons. Such present systems are clearly unsuitable for material characterization applications that require small and/or portable pieces of equipment.

It is desirable, therefore, to provide a low energy neutron generator for non-destructive examination of possible nuclear fission material, and to provide a portable electric proton source suitable for making low energy neutrons.

### SUMMARY OF THE INVENTION

Embodiments of the present invention are directed to a source of low energy neutrons based on a combination of unique technology that is implemented in a man-portable package suitable for field use. This source of low energy neutrons produces a forward directed beam to permit local control and it is electrically activated so there is no radiation hazard when it is turned off for transport and relocation.

A portable Radio Frequency Quadrupole (RFQ) suitable for accelerating particles useful for making neutrons is provided. In-field material characterization is achievable with a portable, electrically generated, low energy (e.g., less than 100 keV) neutron source. Low energy neutrons are obtained in an accelerator where the target does not deplete, but instead is self-replenishing. The combination vacuum system/RFQ effects size reduction in the neutron source (Cu coated Al). Real-time in-field stabilization under temperature drift is accomplished by measuring accelerator voltage standing wave ratio (VSWR). This is used to provide feedback to a voltage-controlled oscillator (VCO) to adjust the accelerating waveform to match the resonant frequency needed in the accelerator. An antenna that is located in the gas flow drives a compact ion source. An annular ion source gas fill aperture reduces the gas loading on the accelerating portion of the vacuum system. Size and weight of the equipment system are reduced with an air-cooling system. A low-voltage, pulsed-RF (radio frequency) acceleration of particles approach is used to obtain useful nuclear reaction in the portable accelerator. The portable neutron source is directional in beam emittance, via kinematics selected by accelerating potential. A supplementary accelerating potential is provided to tune the final beam to match a nuclear resonance in the target and therefore obtain the directional emittance.

Applications for this invention are found in physics research on nuclear cross sections, non-destructive assay of material, high contrast (low gamma-ray, low energy spread) neutron beams for radiography, thermal neutron radiography of parts in situ (in the field), contraband detection, neutron beam research, and in oncology (BCNT).

### BRIEF DESCRIPTION OF THE DRAWINGS

Embodiments are illustrated by way of example and not limitation in the figures of the accompanying drawings, in which like references indicate similar elements and in which:

FIG. 1 is a block diagram of a portable neutron generator under an embodiment.

FIG. 2 illustrates an exploded view of the components of the ion source chamber, under an embodiment.

FIG. 3 illustrates the structure and orientation of the magnet for the ion source, under an embodiment.

FIG. 4 illustrates an Einzel lens assembly for use in the extractor section, under an embodiment.

FIG. 5 illustrates an ion source vacuum chamber for housing the Einzel lens assembly, under an embodiment.

FIG. 6 is a block diagram illustrating the components and configuration of a 2.4 GHz RF amplifier and power source for generating protons, under an embodiment.

FIG. 7 illustrates an RFQ linac used in a neutron generator according to an embodiment, and as viewed from one end and looking down the axis of the linac tube.

FIG. 8 illustrates the RFQ linac according to an alternative view with an RF drive loop inserted from the side.

FIG. 9 illustrates a detailed view of the RF drive loop, under an embodiment.

FIG. 10 is a circuit diagram of a self-tuning frequency circuit for use with the RF power supply, under an embodiment.

FIG. 11 illustrates an endplate for the RFQ linac, under an embodiment.

FIG. 12 illustrates a lithium target mounted on a target plate containing radial cooling fins, under an embodiment.

FIG. 13 is a more detailed view of the lithium target of FIG. 12.

FIG. 14 illustrates a side view of a lithium target assembly, under an embodiment.

FIG. 15 illustrates a Halbach array of the expander section, under an embodiment.

FIG. 16 illustrates a neutron generator equipment assembly 1600 that embodies a neutron generator 100 under an embodiment.

FIG. 17 illustrates a side view of the linear accelerator portion of the neutron generator of FIG. 16.

FIG. 18 shows neutron source yields using low energy nuclear reactions.

FIG. 19 shows neutron output energy for the ⁷Li(p,n) reaction.

FIG. 20 shows neutron output angles for a ⁷Li(p,n) reaction.

FIG. 21 is a graph that shows a 7-Li proton capture reaction, under an embodiment.

### INCORPORATION BY REFERENCE

Each publication and/or patent mentioned in this specification is herein incorporated by reference in its entirety to the same extent as if each individual publication or patent was specifically and individually indicated to be incorporated by reference.

### DETAILED DESCRIPTION OF THE INVENTION

Embodiments of a portable, electrically generated, low energy neutron source that has been developed for in-field material characterization applications are described. Many areas of novelty have been assembled into this new approach to neutron sources. This new system makes use of low-voltage, pulsed-RF acceleration to obtain energetic particles useful in nuclear reactions that produce low energy neutrons.

The portable accelerator includes a portable radio-frequency linear accelerator based on the Radio Frequency Quadrupole structure (RFQ) designed to accelerate charged particles of hydrogen (i.e., protons) to energies useful for producing neutrons with the (p,n) reaction on lithium. This small accelerator uses low power vacuum pumps to effect a size and weight reduction for the system as compared to present neutron generators. The RFQ accelerator is designed with air-cooling fins integral to the one-piece vacuum system and accelerating cavity and the complete system is air cooled to reduce the size and weight of the compact accelerator unit. A compact ion source developed for commercial use with heavy ion accelerators was modified to operate as a pulsed source of hydrogen ions. A boron nitride liner is placed in the plasma chamber and a new magnetic profile was developed for operation of the ion source. This ion source is driven by a coaxial feed and a spiral antenna was added to more effectively couple the microwave power into the plasma. An annular ion source extraction aperture was used to reduce the gas loading on the vacuum system while maintaining the gas pressure in the plasma chamber necessary for extracting a proton beam up to 5 milliamps. The diameter of the annulus and the center block are sized to optimize the ion extraction and emittance to the linear accelerator (linac). The center block is attached with small spider legs. A differential pumping scheme is used to balance the need for a high gas load on the ion source end, with its own pump and good vacuum on the accelerator end. The differential pumping scheme works by pushing the ions through a small aperture that does not conduct un-ionized gas well.

The RFQ accelerator includes resonant frequency stabilization under the temperature drift caused by operation that uses the measured accelerator RF phase to provide feedback to a wide range voltage controlled oscillator (VCO) which adjusts the drive frequency of the RF power supply to match the resonant frequency needed in the accelerator. This wide range VCO allows operation of the RFQ linac over a wide range of operating temperature (40 deg. C.) to permit operation of the system in a wide range of field environments. The linac structures are configured to operate at a high frequency to allow miniaturization of the system, requiring the development of a new high-power RF generator. A combination of solid-state components with vacuum amplifiers and a miniature cooling system represents an order of magnitude advance in power to weight ratio at this frequency (600 MHz).

The low energy neutrons are obtained from this system from the bombardment of a lithium-coated target by the energetic protons. The thin layer of lithium on the target does not deplete, but replenishes itself due to the beta decay process. It is covered with a very thin layer of inert material to prevent oxidation. The target assembly is mounted on the output of the accelerator with high voltage isolation so that a bias can be used on the target to make fine adjustments to the energy of the protons hitting the target to compensate for the energy lost in the passivation and to adjust the beam energy to provide neutrons only in the forward direction. This supplementary accelerating potential is not a de/dx filter as in Powell, but is used to tune the final beam to not exceed a limit above the threshold in the Li(p,n) nuclear reaction so that the emitted neutrons are only in the forward direction.

The RFQ accelerator, ion source, RF power supply and all ancillary equipment are housed in two lightweight packages that are portable and capable of being interconnected to effect full operation rapidly. The lightweight housings use modern carbon fiber covers to make them rugged and capable of protecting the system from damage while not affecting the neutrons emitted from the target.

There are many possible scenarios for active interrogation of container cargo. Compared to a classic nuclear physics laboratory environment, cargo scanning introduces the need to deal with enormous amounts of background discrimination and attenuation, which imposes very different constraints compared to systems that measure nuclear properties in a clutter free environment, such as in a controlled laboratory. The main problem is the enormous thickness and variety of the possible intervening material, which may approach the thickness of nuclear reactor shielding walls. For some scenarios, either gamma rays or neutrons cannot penetrate the cargo efficiently. On the other hand, it is very difficult to shield gamma rays, X-rays, and neutron penetration at the same time when there is a limit on the weight of the shielding. For gamma rays, heavy elements are difficult to penetrate, whereas for neutrons, light elements like plastic and water are difficult. One very promising active interrogation method includes a combination of three different methods to cover all possible scenarios.

For rather unshielded SNM like Uranium 235 (mixed with U238) or Pu239 and other SNM materials are easily detected by passive radiation measurement with large gamma ray scintillation detectors and thermal neutron detectors.

A heavy material shielded container in a light neutron absorbing surrounding is easily observed with a high energy X-ray scan of the cargo, preferably two-axis and two different X-ray energies for better material identification, much like a large airport luggage scanner. The detection of a heavy and very dense object in the middle of a large amount of hydrogenous material (like oranges in crates) will be very suspicious and is usually not encountered in normal shipping containers.

Active neutron interrogation of a container without a large amount of homogeneously distributed hydrogenous material can unmistakably detect the presence of SNM. The active interrogation needs to be exclusively sensitive and specific to SNM like 235U or 239Pu, and not confused by passive materials like Thorium, which is present in many materials at a significant level. To provide meaningful detection, the return signal of the active interrogation must be unique to the presence of SNM, and should produce no signal from the many tons of “inert” material present in a typical container.

One unique method of interrogation which is very specific to SNM and produces an essentially background free return signal very specific to SNM involves sending out medium energy neutrons in the energy range between 10 and 200 keV, and observing the induced 1 MeV to 5 MeV fission neutrons from SNM with pulse shape and energy discriminating scintillation detectors. This method produces a nearly background free identification signal for SNM. Even a small number of detected fast neutrons will be a positive signal, since the fast neutron background from natural sources is very low.

The source of medium energy neutrons is the (p,n) reaction of a 2 MeV proton beam on a 7-Li target. Since the early days of nuclear physics it has been known that one can produce medium energy neutrons with the ⁷Li(p,n) reaction, but since there was little physics use for a medium energy neutron source, this reaction was rarely used and very few accelerators have been built to make use of this reaction. The ⁷Li(p,n) reaction has a threshold of 1.88 MeV and the cross section rises to its full value within 20 keV proton beam energy. In general, it is a very sharp threshold reaction. If one chooses a proton energy just above the reaction threshold, it is possible to restrict the neutron emission pattern to a 60 degree forward cone. In this case, there are no neutrons emitted backwards from the target. The narrow opening angle enhances the effective forward neutron flux by a factor of ten compared to 4π emission sources and reduces the neutron activation of the surrounding dramatically. There is also no need for bulky and heavy sideway neutron shielding, thus allowing the placement of fast neutron detectors rather close to the accelerator and target.

The ⁷Li(p,n) reaction produces a kinematically forward focused neutron beam, requiring little sideway shielding. Since the outgoing neutrons have rather low energy, the radiation dose delivered to the cargo is rather low and is generally not a threat to equipment or humans in the cargo. Neutron production rates can be as high as 10¹⁰ per second into a 1 steradian cone, which is equivalent to a ten times higher strength source emitting into 4π with a strong source. This allows a complete cargo container scan to be accomplished in less than one minute.

In an embodiment, the portable neutron generator that includes a 2 MeV accelerator for producing the required 2 MeV neutron beam is less than half the size of a typical office desk, is portable, plugs into a regular electrical outlet and requires no cooling water. Such embodiments can be modified to also build a very tightly focused neutron beam by reversing the ⁷Li(p,n) reaction to ¹H(⁷Li,n). The benefit is a very narrow and high brightness neutron beam, however, such an accelerator to produce 14 MeV ⁷Li may be much larger and much more expensive to build.

Fast neutron sensitive detectors are a key to the nearly background free detection of SNM. Sending out a high flux of neutrons into a random cargo will produce a significant gamma radiation, since most neutrons will not die “gracefully” without the emission of very energetic gamma rays. The typical neutron capture reaction releases about 7-8 MeV of gamma rays, independent of whether the reaction product is a stable nucleus or not. The detector must be able to distinguish between the gamma rays and the energetic neutrons. Discriminating liquid scintillator detectors were developed many years ago, and the pulse shape discriminating read-out electronics has been steadily improved in the last 20 years. The development was mainly driven by the development of low background detectors for deep underground astro-physics instruments.

The gamma-neutron separation is very much influenced by the actual count rate in the detector, so it is beneficial to keep the absolute count rate rather low to eliminate pileup confusion. The typical detector array is segmented to keep the individual detectors volume to less than one liter. Several arrays of one square meter on each side of the neutron source and on the opposite sides of the container should be sufficient.

Tests of the neutron generator according to embodiments described herein have shown that there is near zero background in the fast neutron detectors, even while the interrogating neutron beam is on. This makes it possible to detect SNM with only a few tens or hundreds of counted high-energy fission neutrons. In an embodiment, the system implements a digital event readout and analyzes each potential fast neutron pulse through software to thereby improve the gamma to neutron separation. Since the fast neutron count rate is rather small, a sophisticated analysis of the pulse shape and its decay structure can be performed. When neutrons collide with hydrogen nuclei in the detector material, they can transfer much of their energy to the hydrogen nucleus. The recoiling proton excites different molecular states in the scintillator compared to a fast electron produce by a gamma ray interaction. The light decay time for a proton induced light pulse is much longer than the electron induced pulse. A clever analog electronic circuit can distinguish the pulse shape, but may be confused at high-count rates. A fully digital readout practically eliminate this problem and give a much cleaner neutron signal, even in a high gamma ray environment. To reduce the total count rate in the detector without losing too many neutrons, the detector array can be shielded behind a one-inch lead wall, or appropriate thickness for the operational environment.

The free path length of fast neutrons in materials is rather short, typically between 2 and 5 cm for most materials. The free path length between elastic scatterings is independent of atomic mass, making most materials look the same for neutron penetration. The only exception is hydrogenous material like polyethylene or water. In this case, the typical scattering length is less than two cm, making it harder to diffuse neutrons. Neutrons lose some energy in every collision; the typical loss is proportional to the atomic weight ratio of the neutron and the scattering nucleus. Neutrons lose their energy relatively quickly in water, but they can scatter for many meters in heavy material before they thermalize and are ultimately captured.

In water, the useful diffusion depth is about 30 cm. In heavy materials, a container full of tools or electronics is not an obstacle. The 60 keV outgoing neutrons will have penetration depth of about ½ of a multi-MeV neutron beam. Most of the diffusion length comes from the random walk of the ever-slowing neutrons at lower energies. The energy loss is an exponential process, so very energetic neutrons rapidly slow down to medium energies, and then follow the same diffusion path as original 60 keV neutrons. At higher energies, neutrons lose much of their energy by inelastic excitation of the target nuclei, producing unwanted additional gamma radiation.

A large portion of the fission reaction in SNM is caused by thermalized neutrons.

Here the fission cross-section is very large for 235U and 239Pu. The fast fission neutrons with an average energy of 2 MeV have to be able to exit the container, reversing the path of the interrogating neutrons. Only neutrons that do not lose too much energy on their way out can be counted, since the area is flooded with low energy interrogating neutrons.

When using high-energy neutrons for interrogation and waiting for the 1% delayed neutron fraction after the probing pulse is turned off, the problem of penetration depth is reversed. The high-energy inward neutrons have a somewhat deeper penetration potential but the delayed neutrons returning to the detector have only an average energy of 400 keV. So the problem of reduced penetration depth is essentially reversed for high-energy neutron interrogation. If high-energy fission gamma rays are used for the return signal, the low energy neutron problem is circumvented. However, the difficulty with prompt or delayed fission gamma rays is the fact that most are at low energy, and rather few are in the multi-MeV region with very few and weak distinct lines. The fission products are spread out over many different isotopes.

Most neutrons will scatter in the cargo material until the neutrons reach thermal energy, and only then are they lost by a capture reaction. Most bulk materials with very few exceptions have very small capture cross-sections for energetic neutrons. The elastic scattering energy loss mechanism depends strongly on the atomic mass of the material; in non-hydrogen bearing material it takes hundreds or thousands of scattering reaction to reach thermal neutron energies. The long random walk path of the neutron allows it to diffuse up to one meter without severe attenuation. If large amounts of hydrogen are present, the neutrons can lose their energy much faster and the penetration depth is reduced, but even fast neutrons lose part of their energy in the first few collisions and then follow the same path as lower energy neutrons.

The natural fast neutron background in the open environment is generally very low. Neutrons can be generated by cosmic muon induced spallation reactions in the soil and atmosphere. The typical muon flux at the surface of the earth is approximately 100 muon/m²/sec, and the associated fast neutron flux is about a factor 10 lower. If the interrogating neutron source is pulsed, most of the natural background can be gated out, reducing the effective natural neutron flux to less than 1 neutron/m²/sec. With a short measurement time, even a small number of returned fast neutrons can indicate the presence of SNM. No other material can produce fast neutrons when using medium energy neutrons as an interrogation tool. The threshold for (p,n) reaction on most materials is out of energy range for natural occurring radioactive elements. The very few materials with low neutron producing reaction thresholds can easily be detected by other means.

Since the medium energy neutron interrogation technique is exclusively sensitive to actual SNM nuclei, there is no substitute available for testing and calibrations. This raises an interesting problem in that one needs actual SNM material to test the operational performance of the detection system, but low enriched SNM material is sufficient to test and calibrate the detection system.

Embodiments are directed to a working system for active neutron interrogation by a system that selects a reaction that is very exclusive to the detection of SNM and is not compromised by natural background reactions. In general, 60 keV neutrons can penetrate typical cargo containers quite efficiently. The exception is cargo that has high hydrogen content, but X-rays can usually penetrate such cargo quite easily. Fast neutrons are only produced by SNM material, and normal cargo typically does not produce any background reactions. Detecting fast neutrons on both sides of the cargo gives a clean signal, where the detection of even a few dozen beam-time-correlated fast neutrons is enough for a clean detection. It has been demonstrated that the fast neutron detection system is insensitive to the interrogation medium energy neutron beam. This allows for the measurement of the fast neutron return signal while the interrogation beam is on, using the full intensity of the fast fission neutrons produced. The system is insensitive to ²³⁸U and Thorium that are always present in significant amounts in all materials. It is also insensitive to all other non-SNM material, and delivers a very low biological radiation dose to the cargo for effective detection of SNM.

In an embodiment, a portable neutron generator comprises the main components of: ion injectors; microwave ion source with Einzel lens focusing; radio-frequency quadrupole (RFQ); 600 MHz air-cooled RFQ; sealed lithium target isolated for bias voltage; RF Power supply; compact planar triode system with 150 kW pulsed output (JPAW); differential vacuum system with non-evaporable getter (NEG) pumps; and control panel with display and switches.

Specifications for one embodiment of a mobile neutron generator are provided in Table 1 below.

TABLE 1

| | |
|---|---|
| Accelerated Ions | H+ |
| Output beam energy | 1.93 ± .02 MeV |
| Output beam current | 0.1-5 mA |
| Beam repetition rate | 50-500 Hz |
| Beam pulse width | 1-95 μsec |
| Max. RF duty factor | 0.5% |
| RF peak power (max.) | 120 kW |
| Average beam current | 0.10-25 mA |
| Neutron output | 2 × 10⁶-6 × 10⁸ n/sec |
| Vacuum pressure | <1 × 10⁻⁶ torr |
| Vacuum pumps | NEG pumps |
| Cooling | Forced air |
| Input AC power | 220 V, 1 ph, 10 A (2.2 kW) |

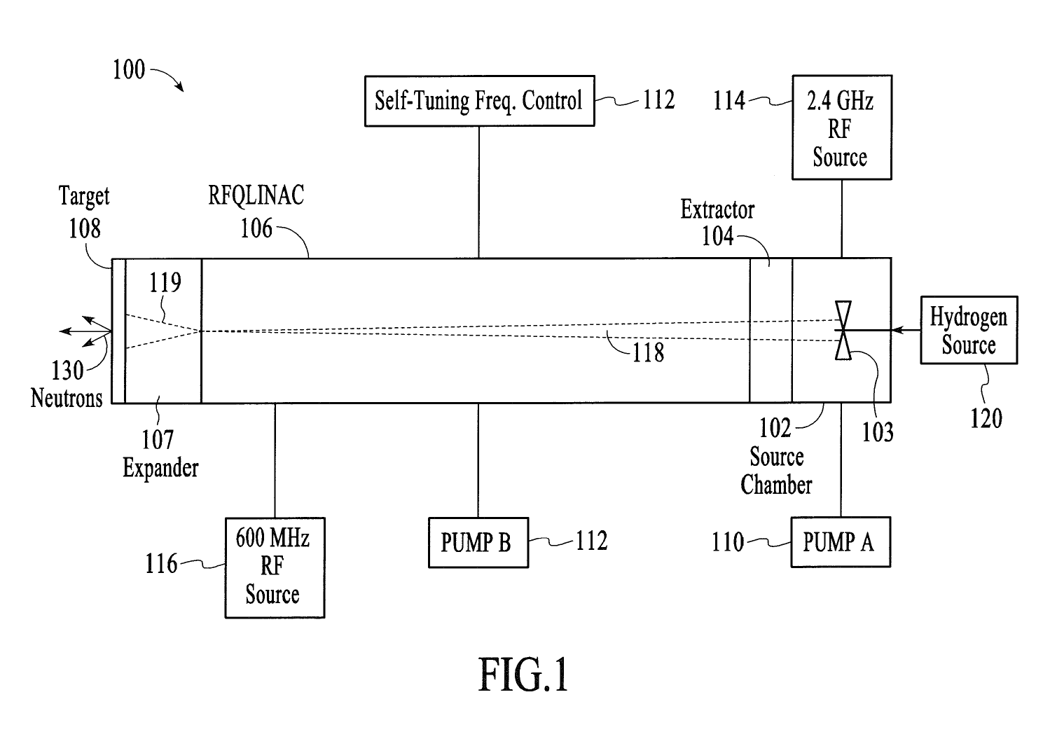

FIG. 1 is a block diagram of a portable neutron generator 100 under an embodiment. As shown in FIG. 1, an ion source chamber 102 generates protons from hydrogen gas. The protons are focused through a lens assembly 104 to create a proton beam 118 that is accelerated through RFQ linac 106, which is powered by RF power source 116. The proton beam 118 is expanded in a post acceleration chamber (expander) 107 to strike target 108, which causes neutrons 130 to be emitted.

The ion source chamber 102 includes a gas inlet that provides entry for hydrogen gas from a gas supply 120. In an embodiment, hydrogen gas is bled into the ion source chamber 102 through the gas inlet. The orifice of the gas inlet is metered to adjust the pressure of the source chamber 102. The pressure is regulated and the gas is ionized to produce a plasma, which comprises the hydrogen gas in which a certain portion of the particles are ionized. A vacuum pump 110 creates a vacuum within the ion source 102 and is used to set the appropriate vacuum level in ion source chamber 102. In an embodiment, vacuum pump 110 is preset to a defined level and is not adjusted. A meter on gas inlet orifice from the gas source 120 is used to control the pressure in the ion source. Alternatively, the gas source can be configured to provide the hydrogen gas at a preset rate, and the vacuum pump 110 may be adjusted to set the appropriate vacuum level.

The ion source ionizes the hydrogen gas within the ion source chamber that is bled in through the gas inlet. The gas supply system comprises a hydrogen gas tank and a pump that introduces (bleeds) hydrogen gas into the ion source chamber through the gas inlet. The inlet comprises a metering orifice that regulates the flow of gas into the source chamber, while the pump flows at a constant rate. The hydrogen gas is used to provide the protons 118 for the ultimate Li reaction on the target 108. The hydrogen is ionized at 13 eV and dissociated to produce the ions. Such an operation typically requires a high amount of RF power, since dissociating hydrogen to generate protons requires a great amount of energy. The ion source utilizes an electron cyclotron resonance frequency and magnetic field combination driven by a solid state 2.5 GHz RF source 114 and antenna 103 to create a high voltage to initiate the discharge. In an embodiment, the ion source chamber utilizes an electronic field in which the electronics cycle at a given frequency to produce an optimum energy coupling. The spiralling of electrons at a specific frequency within the chamber creates an energy coupling that ionizes the hydrogen gas.

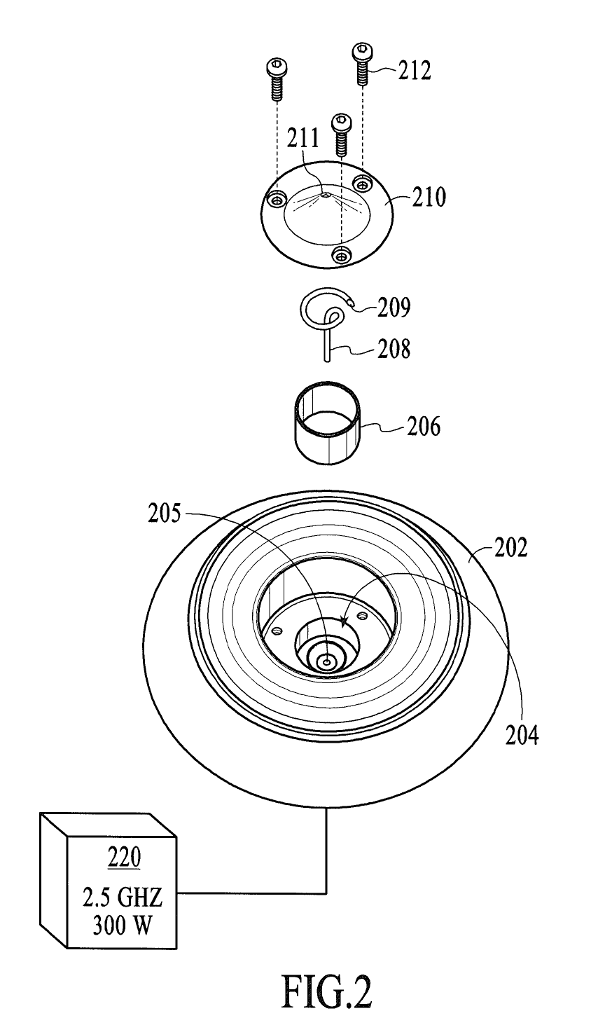

The ion source chamber 102 comprises a magnetic structure disposed around a cylindrical section that includes a boron nitride liner surrounding a radio frequency coil antenna 103. The ion source 102 comprises a low pressure gas chamber into which is applied power through the RF coil antenna. In an embodiment, the antenna is coupled to and driven by a 2.5 GHz RF source 114 at approximately 300 W of RF power. The antenna is fashioned out of steel, or any appropriate material, and configured as a tuned loop of approximately one turn. The antenna is tuned to an electronic field that hits the electron cyclotron frequency. FIG. 2 illustrates an exploded view of the components of the ion source chamber 102, under an embodiment. The ion source housing includes a cylindrical section 206 that includes a coupling hole 205 for insertion of coil antenna 208. The coupling hole 205 may also act as a portion of the gas inlet orifice for introduction of the hydrogen gas from supply 120 into the ion source chamber. A boron nitride liner 206 fits along an interior surface of the cylindrical section 206 to provide insulation.

As shown in FIG. 2, the antenna 208 has a very sharp point 209 to initiate the discharge that disassociates the hydrogen to produce the protons. A solid state 2.5 GHz RF source 220 is coupled to the antenna through an RF coupler when the antenna is inserted into the coupling hole 205, and provides 300 Watts of microwave power to the ion source. The coupling hole 205 may be configured to also function as the inlet orifice and is insulated with a boron nitride layer. The antenna is configured to resonate at the appropriate electron-cyclotron resonance frequency of the source chamber. The antenna is configured to also provide the initial discharge that initiates the hydrogen dissociation process that creates protons from the hydrogen gas plasma. This is provided by the sharpened end 209 of the antenna. The combination of this resonance frequency and magnetic field combination driven by the antenna essentially sparks the introduced hydrogen gas to provide the protons for the ion source.

The boron nitride liner 206 surrounds antenna 208 within the chamber and serves as an insulator by preventing plasma from short circuiting on the side of the chamber. In general plasma is harsh and corrosive, and boron nitride is suitable for insulating a hydrogen source, as it survives the plasma condition.

The use of a ion source chamber as illustrated in FIGS. 1 and 2 eliminates the need for a separate electron source that is often required in present neutron generate systems, as this system represents a self-start mechanism that provides free protons as an initial condition. The ion source antenna 208 thus serves two different purposes. First, it creates the protons to go into the linear accelerator, and second it provides the frequency that is tuned to an electronic field that hits the electron cyclotron frequency.

The cylindrical section 204 of the ion source chamber is capped by a lid or cover 210. Depending upon implementation requirements, the cover 210 can be a flat or contoured lid that is sealed and held in place over the cylindrical section 209 through the use of screws or similar fasteners 212. The ion source chamber cover 210 includes a hole or orifice 211 that allows the protons generated within the source chamber to exit into the linear accelerator portion of the neutron generator. In an embodiment, the diameter of the exit hole 211 is on the order of 2 mm ( 1/16″).

The number of protons created by the ion source is dictated by the flow rate of hydrogen into the ion source chamber. In general, a flow rate of 0.02 cc of hydrogen gas per second is a standard flow rate for a typical gas load. The optimum flow rate must be determined depending on the actual implementation conditions. If too little hydrogen is input into the chamber, not enough protons will be generated, and if too much hydrogen is input, the hydrogen will not optimally ionize.

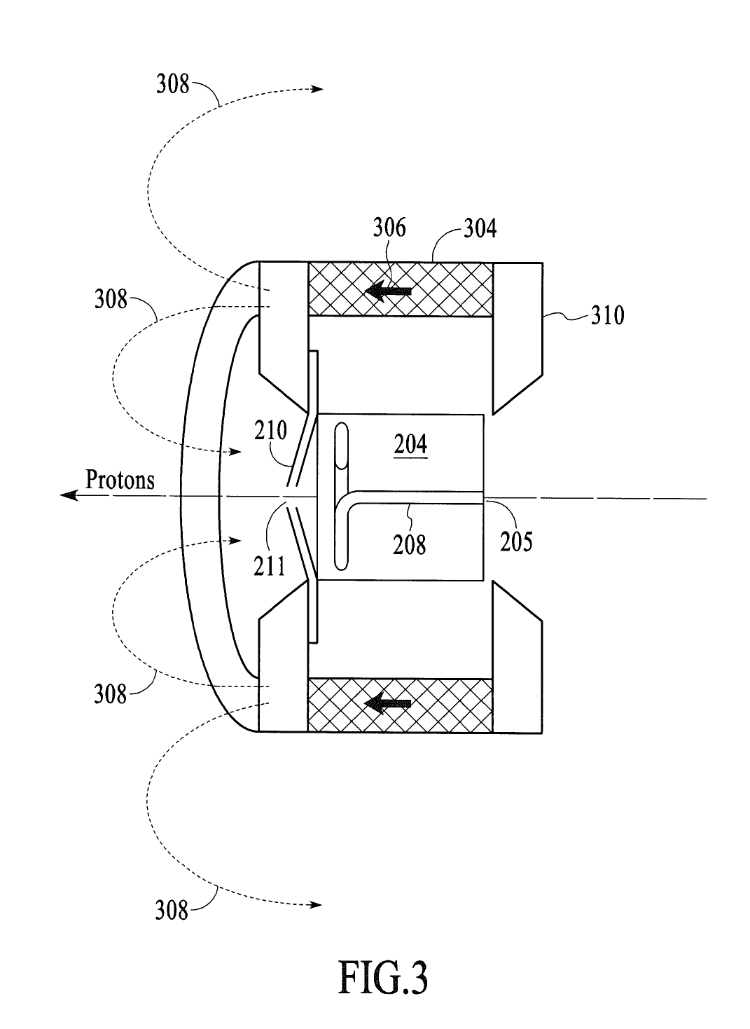

As shown in FIG. 2, the ion source chamber has a simple metal wire antenna tuned to 2.4 GHz and a bore lined with a boron nitride dielectric. The ion source chamber also includes a magnet generally disposed around an outer surface of cylindrical section 204. The magnet is configured to create a magnetic field that is optimized to direct the generated protons through the cover orifice 211 and into the linac 106 section of the neutron generator 100. FIG. 3 illustrates the structure and orientation of the magnet for the ion source, under an embodiment. FIG. 3 is a side view cutaway diagram that shows the ion source chamber 302 containing the antenna current loop 208, cover 210 and outlet orifice 211. The ion source chamber 204 is surrounded by or positioned within a magnetic field generated by magnet 304. In an embodiment, the magnet 302 is an annular ring type magnet that encircles the outer surface of the ion source chamber 204. The magnet 304 is polarized in the direction shown by arrows 306 to generate magnetic field lines 308. The magnet is configured such that a constant magnetic field generated in its center, which contains the ion source chamber, is flat and in reverse relative to the flow of protons. One or more shaped iron pole pieces 310 are used to carry more flux, flatten the field by bending the divergent flux lines so the magnetic field lines are as parallel as possible. In an embodiment, a permanent magnet, such as a speaker magnet can be used. The use of a magnet in this application is advantageous because it is self-powered, and facilitates the portable nature of neutron generator 100.

As shown in FIG. 3, the magnetic field profile 308 generated by the magnet 304 and pole pieces 310 in an optimum configuration is flat with parallel flux lines that are in a direction opposite the flow of protons. A flat field is optimum since only one frequency excites the electrons. A flat field ensures that all of the electrons are exposed to the same energy. This increases number of protons that are stripped (dissociated) from the hydrogen molecules and optimizes the efficiency of generator 100.

As shown in FIG. 3, the hydrogen gas is introduced into the ion source chamber 204 through inlet orifice 205, and the protons that are stripped from the hydrogen molecules are emitted out of outlet orifice 211 in cover 210. With reference to FIG. 1, the ion source chamber 102 is coupled to an extractor section 104 that moves the protons down the RFQ linac. The extractor section 104 sets up and utilizes a high voltage electric field to pre-accelerate the protons for ultimate acceleration through linac 106. In an embodiment, the ion source chamber housing 202 is a metal structure that is set at a high voltage (e.g., 20 KV) relative to ground. In an embodiment, the extractor mechanism sets a 20 KV static electric field around the ion source chamber. Thus, one end of the ion source chamber is at 20 KV relative to the other end of the chamber to pre-accelerate the protons out of the chamber.

In an embodiment, the extractor is a structure that is essentially superimposed over the ion source chamber, and extracts protons out of the source chamber through an Einzel lens assembly. The extractor section 104 generally operates by spreading the protons and allowing them to be focused for acceleration through the linac. The ion source generator provided a high power RF electric field that essentially ripped apart the hydrogen gas plasma to efficiently dissociate the hydrogen molecules efficiently, and the extractor spreads the protons apart by application of a 20 KV field. This generally facilitates the focusing of the protons into as small a beam as possible within the size constraints of the generator 100.

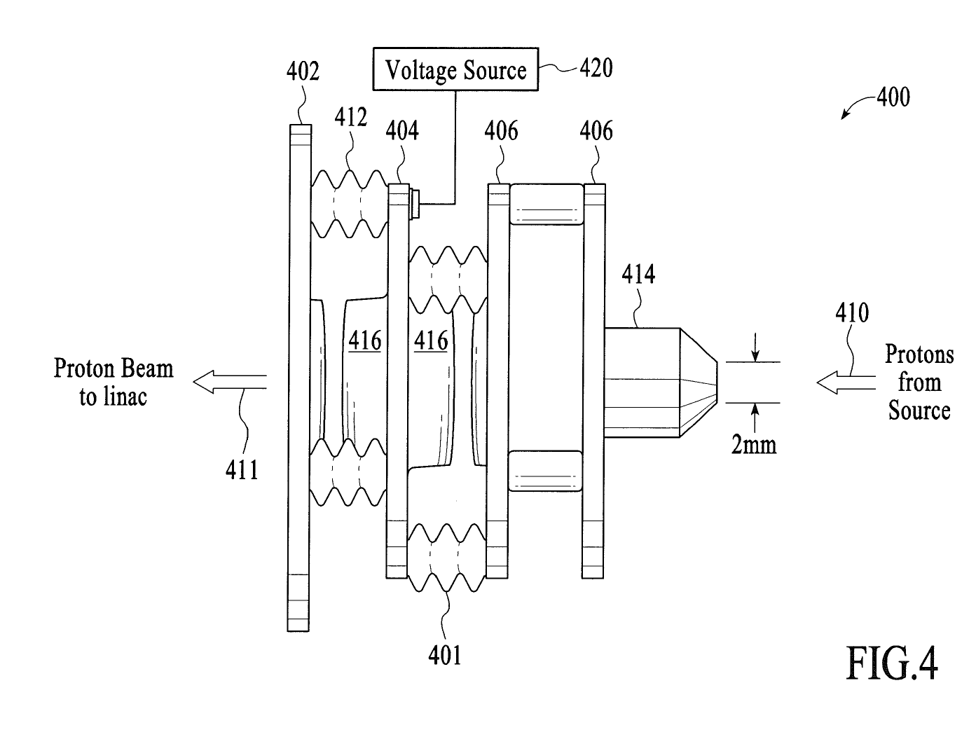

FIG. 4 illustrates an Einzel lens assembly for use in the extractor section, under an embodiment. The Einzel lens assembly 400 includes an Einzel lens section 410 that includes a central electrode 404 coupled to a high voltage source. The central electrode 404 holds and a high voltage cylinders 416 and is coupled to a number of sections each comprising a grounded plate 402 and 406, each containing a 2 mm hole, with insulators 414 separating the sections. Through the action of the high voltage field produced by the central electrode of the Einzel lens, virtually anything within the volume of the lens assembly gets drawn in and focused through the holes. As shown in FIG. 4, an extractor cone 414 couples to the ion source chamber 102 through an appropriate fitting or similar mechanical structure. The exit orifice 211 of lid 210 for the ion source chamber is lined up with the 2 mm hole in the extractor cone 414. The end plate 402 and intermediate plates 406 are grounded relative to high voltage cylinders 416. Insulators 412 provide appropriate insulation between the elements of the lens. The Einzel lens 400 focuses the protons 410 generated in the ion source chamber into a small pencil beam 411 through 2 mm holes in the extractor cone and each plate to the exit end of the lens. From the end plate 402, protons 411 are introduced into the linac section 118. A 2 mm hole in the center of the end plate 402 is aligned to the center of the linac.

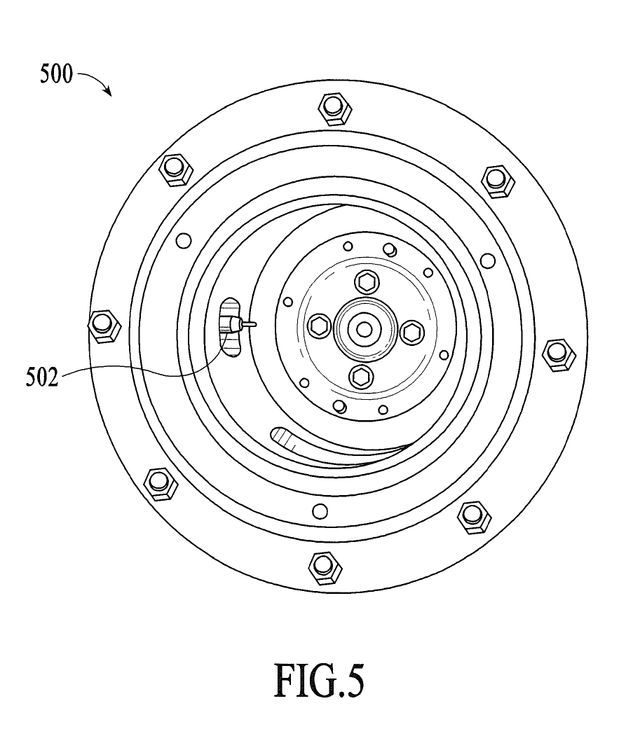

FIG. 5 illustrates an ion source vacuum chamber for housing the Einzel lens assembly, under an embodiment. The ion source vacuum chamber 500 includes sufficient space to accommodate the Einzel lens assembly of FIG. 4. It also includes a 20 kV ceramic insulator. A high voltage lead 502 connects the center electrode of the Einzel lens to the voltage source 420. The ion source chamber 102 also includes inlet ports for a pump that is used to maintain pressure within the ion source chamber at a level on the order of 10⁻⁴ ton. The proton beam enters the RFQ linac through the small hole in the middle. The current measuring toroid surrounds the hole.

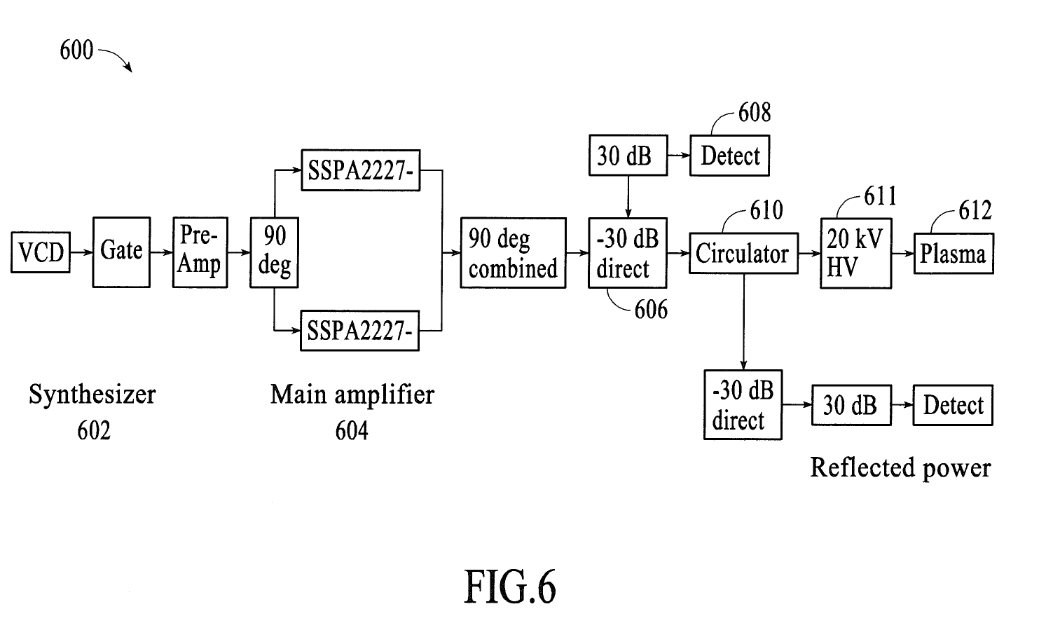

With reference to FIG. 1, the ion source section 102 of the neutron generator is driven by a 2.4 GHz RF source. FIG. 6 is a block diagram illustrating the components and configuration of a 2.4 GHz RF amplifier and power source for generating protons, under an embodiment. The 2.4 GHz RF circuit 600 includes a synthesizer section 600 that includes a voltage-controlled oscillator (VCO) coupled to an on-off gate and a pre-amp. The gate is configured to generate a power cycle that runs on a one-percent duty cycle, so that the source and linac run only around 1 percent, providing a high momentary power and low average power. The main amplifier stage 604 includes two power amplifiers that are fed by a splitter. The amplified signal is then combined and fed into a directional coupler 606. The directional coupler drives a detector 608 and a circulator 610. The circulator prevents reflected power when the plasma does not fire to protect the amplifier stage. The plasma 612 burns at 20 kV. Element 611 represents a high voltage isolator comprising a coax-waveguide-coax converter. The waveguide portion has a high voltage insulation sheet. This provides isolation at 2.5 GHz, whereas a standard transformer would not provide such isolation.

The proton beam generated and focused by the ion source chamber 102 and extractor section 104 is input to the linac section 106 for acceleration to target 108. In general, a good vacuum level must be maintained in the linac 106 to prevent discharge of the protons (fluorescence) within the linac. However, the ion source chamber is at a relatively high pressure due to introduction of the hydrogen gas and ionization activities within the chamber. Thus the generator 100 represents a system in which a portion at high pressure is coupled to a portion at essentially zero pressure and that contains a series of orifices to enable protons to pass through them. To accommodate these different pressures within the same overall structure, a differential pumping scheme is used.

As shown in FIG. 1, the pressure in ion source chamber 102 is controlled by a first pump (pump A) 110, and the pressure in linac 106 is controlled by a second pump (pump B) 112. In an embodiment, the linac 106 pressure is maintained at a level on the order of 10⁻⁶ torr and the ion source chamber 102 pressure is maintained at a level on the order of 10⁻⁴ torr. The differential pumping scheme allows for maintaining a pressure difference of at least two orders of magnitude between these two adjacent sections. The high pressure in source section relative to the low pressure in the linac section is maintained by the 2 mm hole in the extractor section. In an embodiment, both pumps 110 and 112 are configured to pump at the same rate, such as on the order of 200 liters/second. Pump 110 removes hydrogen from ion source chamber 102 and pump 112 takes out any residual hydrogen and maintains vacuum for the linac. The 2 mm orifice between the two sections creates a differential pumping condition. In general, the power of the pumps is related and selected to match the size of hole and amount of hydrogen that is bled into the ion source chamber. In an embodiment, Non-Evaporable Getter (NEG) pumps, such as those made by SAES Getters Company are used for pumps 110 and 112. In general, such pumps are of a size and operational character that is suitable for installation within the portable generator 100.

A main portion of the neutron generator 100 comprises the RFQ linac (Radio Frequency Quadropole Linear Accelerator) section 106. The RFQ linac generally consists of a metal tube of a length of approximately 80cm long. The function of the linac is to accelerate and focus the proton beam to a sufficient speed and beam diameter to effect the ⁷Li(p,n) reaction when the protons strike the lithium target 108 to produce neutrons 130. The operating parameters for the RFQ linac for an example embodiment are provided in table 2 below.

TABLE 2

| Operating frequency | 600 | MHz |
|---|---|---|
| Input beam energy | 18.0 | keV |
| Output beam energy | 1.93 | MeV |
| Vane length | 81.5 | cm |
| Average bore radius (r₀) | 1.39 | mm |
| Intervane voltage (V₀) | 55.5 | kV |
| Cavity RF power (theoretical × 1.4) | 98 | kW |
| Calculated beam transmission | 90.7% | |
| Output energy spread (95%) | ±20 | keV |
| Input acceptance (norm, 95%) | 0.52 | p mm-mrad |
| Current limit | 36 | mA |

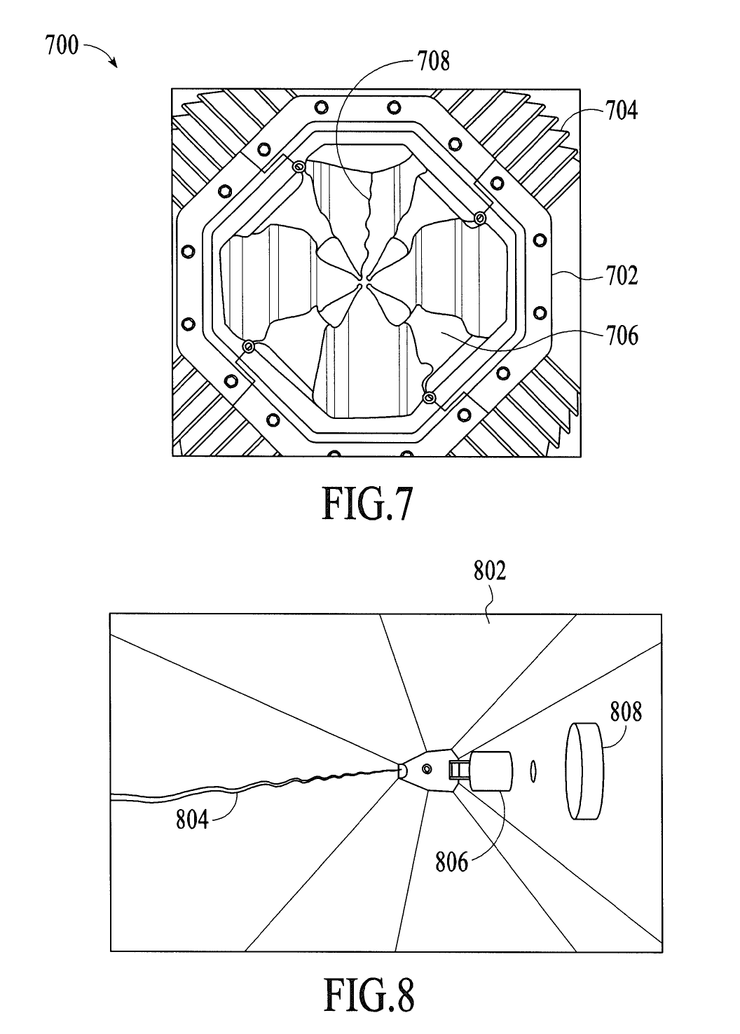

In general, an RFQ is a special vane-type accelerating structure that is used to linearly accelerate protons also provides quadrupole focusing by electric fields near the axis. FIG. 7 illustrates an RFQ linac used in a neutron generator according to an embodiment, and as viewed from one end and looking down the axis of the linac tube. In an embodiment, the RFQ linac comprises an 80 cm long resonant cavity. The linac 700 comprises a housing 702 that includes a series of cooling fins mounted on the outer surface of the housing and running longitudinally down the length of the housing. The interior of the housing has four vanes that also run along the length of the housing. The vanes extend to the center of the interior of the linac and the vane tips are separate by a gap on the order of 2 mm. This gap represents the accelerating axis of the linac and defines the path through which the proton beam travels. The vane tips are shaped to produce a path 708 down the longitudinal axis of the linac that is roughly zigzag in appearance. Thus, the four vanes do not project straight, but in a spiral along a center point of the linac, thus creating a zigzag path for the protons. Such a system is known colloquially as a “wiggler.” The RFQ path 708 is configured to pass one particle at a time and at only one frequency. In this configuration, the proton accelerates as it goes down the linac as the four vane tips produce a 70 kV peak-to-peak gradient with a net forward propulsion.

As shown in FIG. 1, the neutron generator includes a 600 MHz RF source to power the linac. Using this power supply, the vanes have approximately 70 kilovolt potential peak-to-peak, with a 25 kilovolt mean potential to drive the protons through an acceleration potential of two megavolts. To prevent arcing across the vanes, the radio circuitry of RF source 118 is pulsed so that it shuts off just before arcing occurs. The pulsed power source operates generates 150 kilowatts of power and alternates between turning on to create the electric field to give electrons a start and shutting down before arcing occurs. For use in a portable neutron generator, the linac is relatively small. This size reduction is accomplished by utilizing the relatively high frequency level of 600 MHz, which is in the TV band. In an embodiment, the RF source 116 utilizes vacuum tube amplifiers in a multi-tube array to provide the required power.

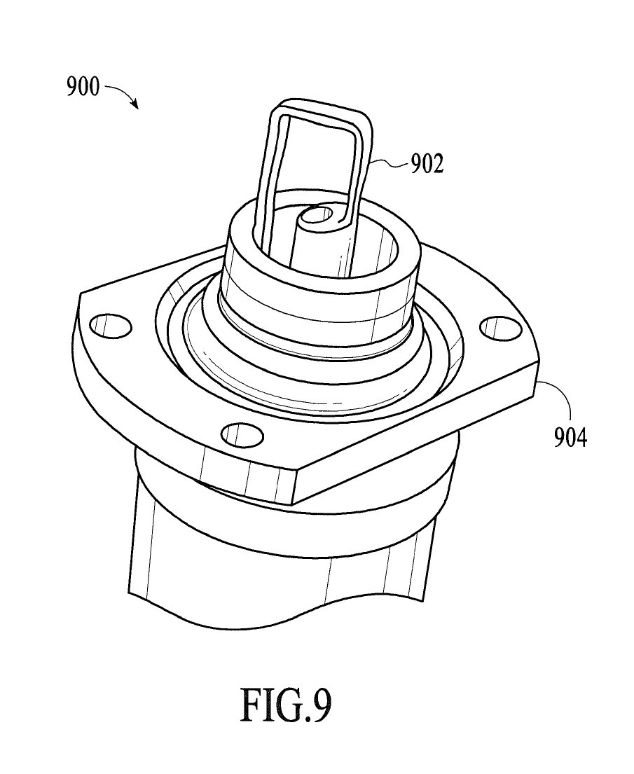

In an embodiment, the RF power from power supply 116 is input to the linac 106 through a drive loop. FIG. 8 illustrates the RFQ linac according to an alternative view with an RF drive loop inserted from the side. This view shows the interior of the linac tube 802 with the proton path extending longitudinally down the axis of the linac. A series of plugs 808 mounted on the inside surface are used to tune the microwave to be even on each side of the linac. These are copper plugs that are used to tune the cavity frequency. One or more of the end plates on either end of the linac may also have similar tuning plugs. As also shown in FIG. 8, the tip of an RF drive loop is inserted into the side of the linac tube 802. The RF drive loop is essentially an antenna that is inserted into the linac to couple in microwave power to maintain the frequency of the linac.

FIG. 9 illustrates a detailed view of the RF drive loop, under an embodiment. Drive loop 900 is basically configured to be a tuned antenna to couple the 150 KW of microwave power provided by the RF power source 116 into the linac RFQ. The closed loop tip portion is inserted into the side of the linac tube and is held in place and mounted by a flange 904 attached to the outside surface of the tube.

For proper operation, the linac tube must be maintained at the precise required frequency, which requires that the mechanical and electrical properties of the linac structure must remain constant. Under normal operating conditions, however, the characteristics of the linac are subject to change due to temperature and humidity changes. These can cause thermal expansion or contraction that can unduly affect the operating characteristics of the linac and throw the operating parameters out of tolerance. Prior art linear accelerators, such as those used in laboratory conditions typically compensate for frequency drift by changing the length of the linac tube itself to keep it on resonance. Such systems rely on thermal management through water cooling, and can therefore require much equipment in the form of plumbing, radiators and water supply.

In an embodiment, the linac stage 106 of neutron generator 100 includes a self-tuning frequency control system 112 that includes a self-tuning radio circuit to accommodate warm-up cycles and environmental changes. Cooling is provided by forced air cooling systems. As the linac tube lengthens and shortens due to environmental conditions, the frequency is adjusted automatically to compensate for frequency drift due to any change in linac tube dimensions. The self-tuning frequency control 112 operates by maintaining the proper standing wave in the linac by peaking on the standing wave reflection and locking in on that frequency.

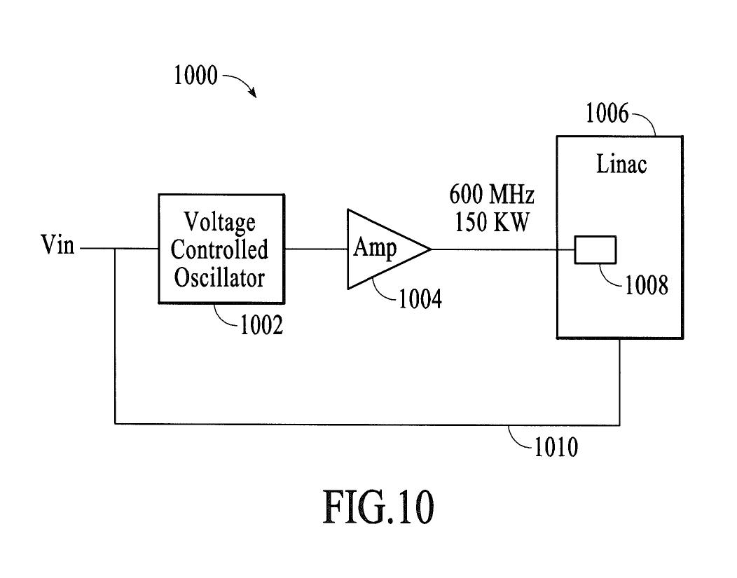

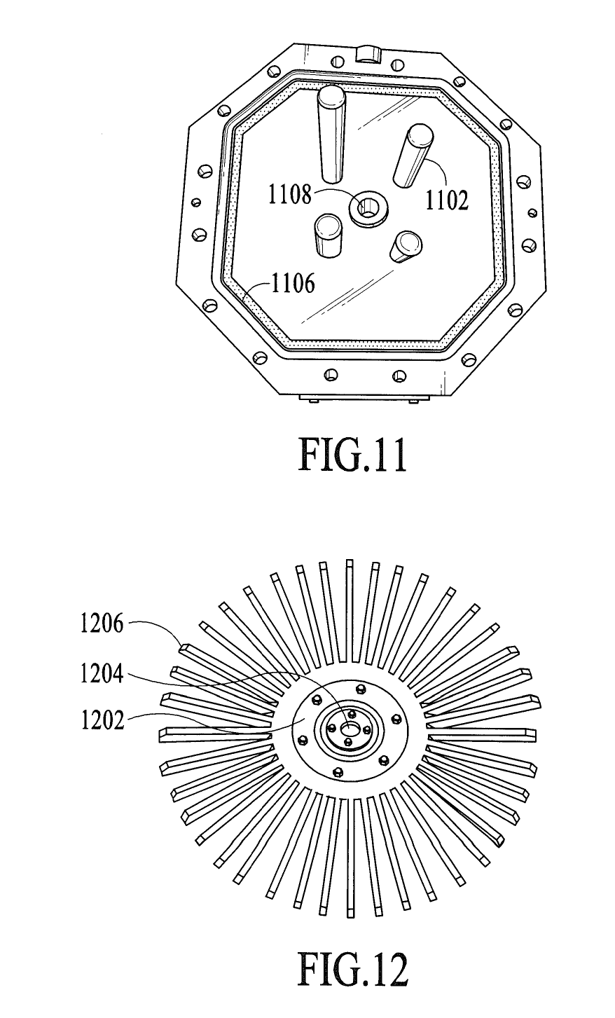

Unlike present systems that do not use frequency adjustment for compensation, but instead change the length of the linac pipe through slugs to change the structure shape, the linac 106 utilizes microwave circuitry that is self-tuned on resonance, as provided by a microwave control circuit. FIG. 10 is a circuit diagram of a self-tuning frequency circuit for use with the RF power supply, under an embodiment. The circuit locks and maintains the defined frequency at the maximum amplitude. Circuit 1000 includes an input voltage stage that provides input voltage Vᵢₙ to a voltage controlled oscillator (VCO) 1002. The VCO is configured to generate a 600 MHz signal that may be output on the order of milliwatts. This signal is fed to an amplifier 1004, which boosts the power of the signal to provide 600 MHz at 150 kilowatts to linac 1006. The RF energy is coupled to the linac through drive loop 1008. The linac represents a tuned circuit of a specific length (e.g., 80 cm) that maintains a voltage standing wave ratio (VSWR) at the frequency of the drive loop. A feedback loop 1010 maintains the Q (quality) factor of the linac by constantly monitoring the VSWR in the linac and providing a measure of the linac voltage back to VCO 1002. This allows the frequency generated by VCO 1002 to be adjusted. The frequency value provided by the VCO controls how much power goes into RFQ linac. The feedback loop serves two uses as it is used to both maintain the resonant power at a maximum level in the RFQ linac, and also to correct the proton energy for the proton beam traveling down the linac path.

The linac 106 is capped proximate the target end with an endplate. FIG. 11 illustrates an endplate for the RFQ linac, under an embodiment. As shown in FIG. 11, endplate 1100 includes four tuning plugs 1102 protruding into the linac tube. The tuning plugs comprise copper slugs that can be moved into or out of the linac tube to the same or different defined distances. The length of each tuning plug can be set to shift the phase of each segment by a quarter wave. The length of the tuning plugs effectively help tune the Q factor of the linac to maintain the maximum VSWR value. An RF seal 1106 surrounds the mating portion of the endplate, and the proton beam exits through the 2 mm hole 1108 in the center of the endplate.

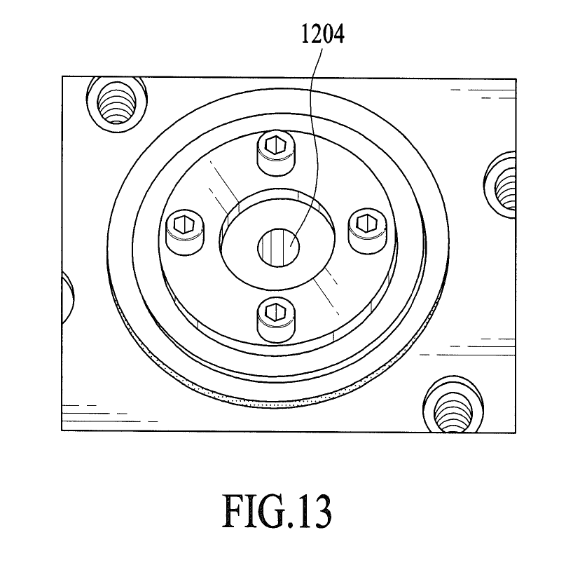

Once the proton beam exits the endplate it strikes the lithium target 108. FIG. 12 illustrates a lithium target mounted on a target plate containing radial cooling fins, under an embodiment. The target plate 1202 provides the structural is coupled to the RFQ linac through appropriate fastening means and provides a rigid support structure for the lithium target 1204, and can be made of aluminum or other similar material. The lithium target is a circular target placed in the center of the support structure 1202. A number of cooling fins 1206 each of about 4 mm thick protrude from the outer circumference of the target plate 1202 to provide for heat dissipation during the proton beam impact. The entire target plate assembly with cooling fins is on the order of six inches wide in diameter. FIG. 13 is a more detailed view of the lithium target of FIG. 12. As shown in FIG. 13, the central circle 1204 represents the lithium target. In an embodiment, the lithium target 1204 is a 10 micrometer thick pure lithium layer of a diameter on the order of 5 mm. The lithium target is coated with 100 nm Chromium and 100 nm Aluminum, on a 2 mm thick silver backing.

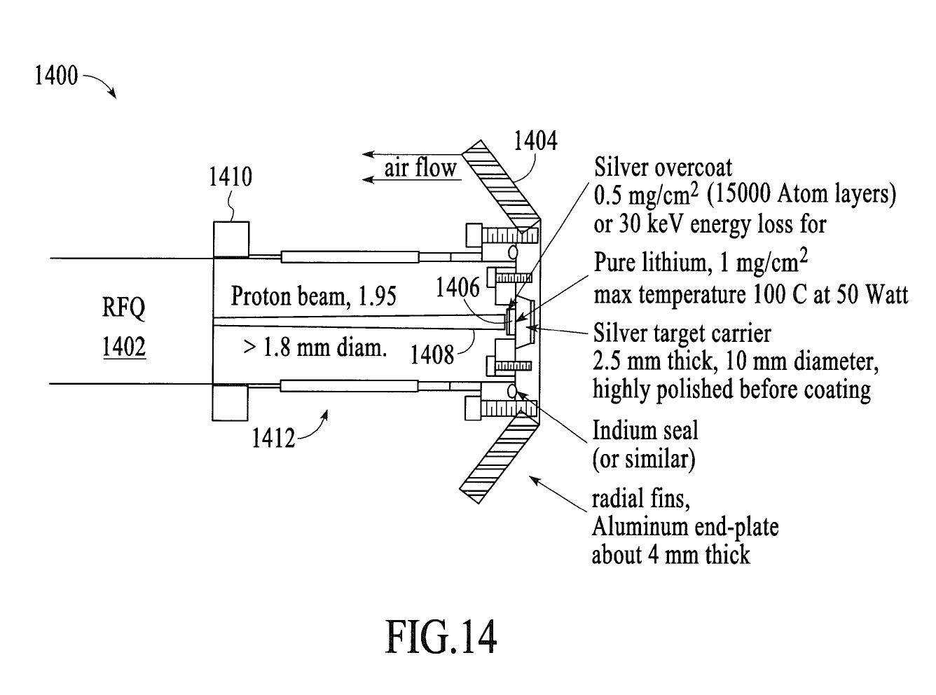

FIG. 14 illustrates a side view of a lithium target assembly, under an embodiment. The lithium target (Li7) 1406 is coated on a silver target carrier and is held on target plate assembly 1404 that is mounted on an assembly structure that maintains the lithium target at a distance of approximately 7 cm from the end of the RFQ linac 1402. The assembly structure includes ceramic members 1412 and various screws and clamp rings, and other appropriate fastening members. An external forced air system provides cooling air that flows through the cooling fins of target plate assembly 1404. Since lithium melts at around 130 degrees Celsius, some amount of air cooling is usually required.

In an embodiment, the lithium target assembly 1400 also includes a magnet array 1410. This magnet array comprises at least part of a beam expander section that serves to expand the proton beam from a highly focused beam as it exits the RFQ 1402 into a more scattered beam 1408 before it hits the target 1406.

The RFQ linac accelerator 106 is configured to produce as small a proton beam as possible to keep the protons away from walls of the RFQ. In a standard configuration, the average beam power is on the order of 5 milliamps with a maximum peak current of 8 milliamps. The beam is concentrated to a point that is sufficient to burn a hole in any target that it strikes. Therefore, the beam must be expanded back out so that it can usefully strike the target. As shown in FIG. 1, the generator 100 includes a beam expander section 107 that expands the proton beam as it exits the linac. In an embodiment, the expander section comprises a powerful expander magnet that expands the beam apart as shown by expanded beam section 119 in FIG. 1.

For the embodiment illustrated in FIG. 14, the expander magnet 1410 comprises a Halbach array of permanent magnets, such as selenium cobalt magnet. The Halbach array is configured as a permanent magnet quadrupole to provide as much expansion as possible within the length of the lithium target assembly, which, in an embodiment, is an approximately 2 inch long section with a ½ inch long magnetic array portion. In an embodiment, the magnet array 1410 provides a 2 mm expansion diameter for the expanded proton beam 1408 as it strikes the target 1406.

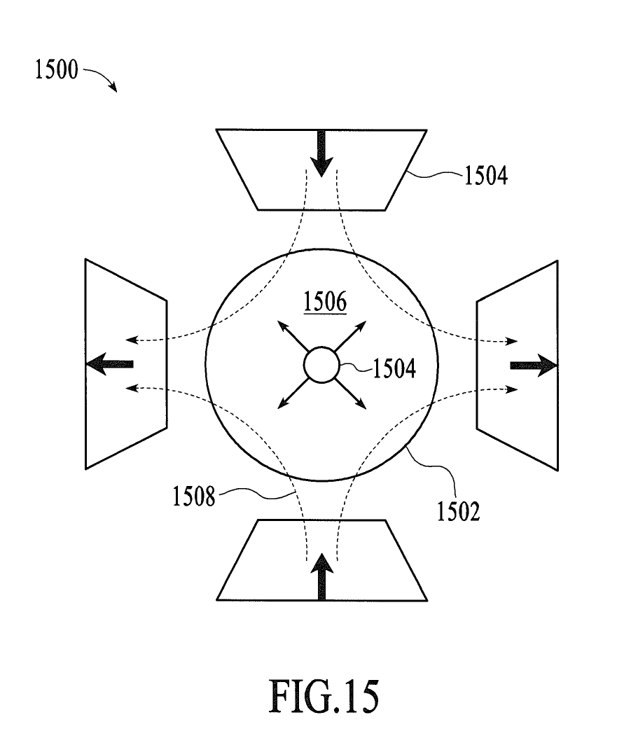

FIG. 15 illustrates a Halbach array of the expander section, under an embodiment. The Halbach 1500 array comprises four pole pieces 1504 disposed around the endplate 1506. The pole pieces set up a magnetic field 1508 as dictated by the Halbach one-sided flux distribution patterns, as shown by the dashed flux lines in FIG. 15. As particles 1506 exit the exit hole 1504 of the endplate 1506 they are diverted in a direction corresponding to the flux lines 1508. Given a properly configured array and powerful enough magnets, the magnetic array 1500 can properly expand the proton beam as it exits the RFQ linac in generator 100.

With reference to FIG. 1, the striking of the proton beam 119 against the lithium target 108 causes neutrons 130 to be emitted from opposite surface of the target plate holding the lithium target in accordance with the ⁷Li(p,n) reaction. It is desired that the neutron beam 130 be as focused as possible for most SNM detection applications. The emission of neutrons in a small collimated beam means that the neutron beam is kinematically focused, and this reduces or eliminates the need for side shielding during detection operations. In general, all tritium or deuterium particles emit in a 4π distribution, which is non-collimated. The proton beam energy must be chosen to be just above the nuclear reaction threshold so that the ⁷Li(p,n) reaction creates a neutron beam in the forward direction and with an appropriate amount of collimation. A relatively high degree of precision is required since it is desirable for the proton energy to be exact to three significant figures for most practical applications.

In general, to effect the ⁷Li(p,n) reaction a proton energy of 195 kV is required to produce a sufficiently collimated neutron beam in the forward direction. However, some variation in proton energy may be present at the target, for example the protons may have an energy of 197 kV. The energy of the linac is fixed, and therefore, cannot be adjusted to compensate for any energy difference. In an embodiment, the neutron generator 100 includes a post-acceleration system to tune the opening angle of the neutron beam 130 exiting the generator and alter or adjust the energy of the impacting proton beam. The post acceleration system comprises a direct current (DC) battery coupled to the neutron generator. This post-acceleration system represents a fine tuning mechanism to compensate for variations in manufacture and represents a calibration adjustment.

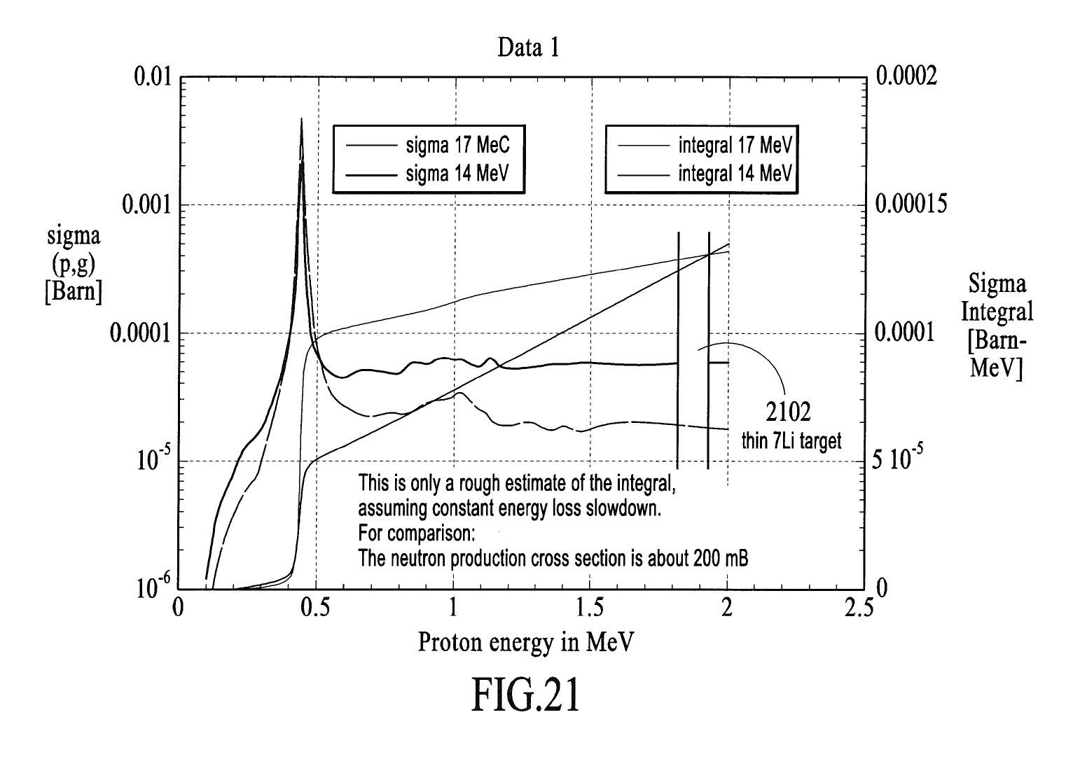

FIG. 21 is a graph that illustrates a 7-Li proton capture reaction, under an embodiment. This graph shows that the lithium target 2102 is configured to be just thick enough to make nuclear reactions. When the protons slow down below threshold, there is no longer any lithium. The density of lithium 1 mg/cm², and in an embodiment, the total amount of lithium in the target is on the order of 0.25 mg.

In general, the lithium target 108 is self-replenishing. This is inherent circumstance of the proton on lithium reaction being self-replenishing by design. The proton impact on the lithium target transforms Li7 to Be7 which decays back to Li7. No change of target is required for the purpose of replacing the lithium. The target may need to be changed to correct for mechanical wear or destruction due to the physical impact of the proton beam.

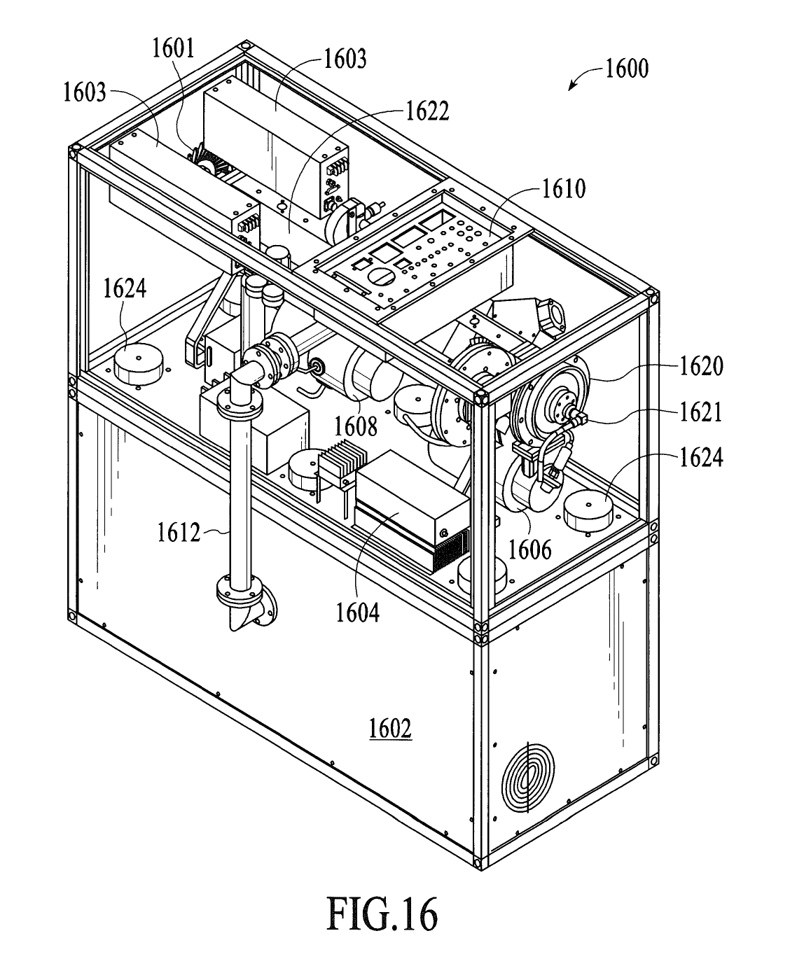

In an embodiment, the neutron generator is manufactured as a portable system embodied in sub-150 lb piece of equipment packaged as 3 modules. FIG. 16 illustrates a neutron generator equipment assembly 1600 that embodies a neutron generator 100 under an embodiment. As shown in FIG. 16, the neutron generator and associated power supplies and circuits are contained within two stackable boxes of dimensions approximately two meters long by one meter high and one meter wide. Assembly 1620 is the ion source that ionizes the hydrogen gas and creates the protons. A hydrogen gas bottle (not shown) is coupled to the ion source 1620 through a gas inlet valve 1621. Box 1604 represents the 2.4 GHz RF power supply for the ion source 1620, and element 1606 represents the NEG vacuum pump for the ion source 1620. Element 1622 represents a portion of the RFQ linac and element 1601 represents the target plate with the cooling fins. Box 1602 contains the 600 MHz pulsed RF power source that drives the RFQ linac. The RF power is coupled to the linac through pipe 1612. Pump 1608 provides the vacuum condition for the RFQ linac. Power supplies 1603 provide power to the generator 1600. In a standard configuration, generator 1600 operates on 2 kilowatts total power. In an embodiment, the power supplies AC power provided by a standard 110 or 220 volt grid. Alternatively, DC batteries and inverter circuitry can be used to provide the operating power. A control panel 1610 provides display and controls for the RF circuitry and the monitoring circuitry. For proper operation the chassis boxes must be rigid and soft mounted for proper operation in a variety of different operating conditions. The generator equipment 1600 includes soft mounts 1624 at each corner to prevent undue shock or vibrations. The embodiment of FIG. 16 illustrates the packaging of the neutron generator in a portable and ruggedized configuration for transporting to remote locations.

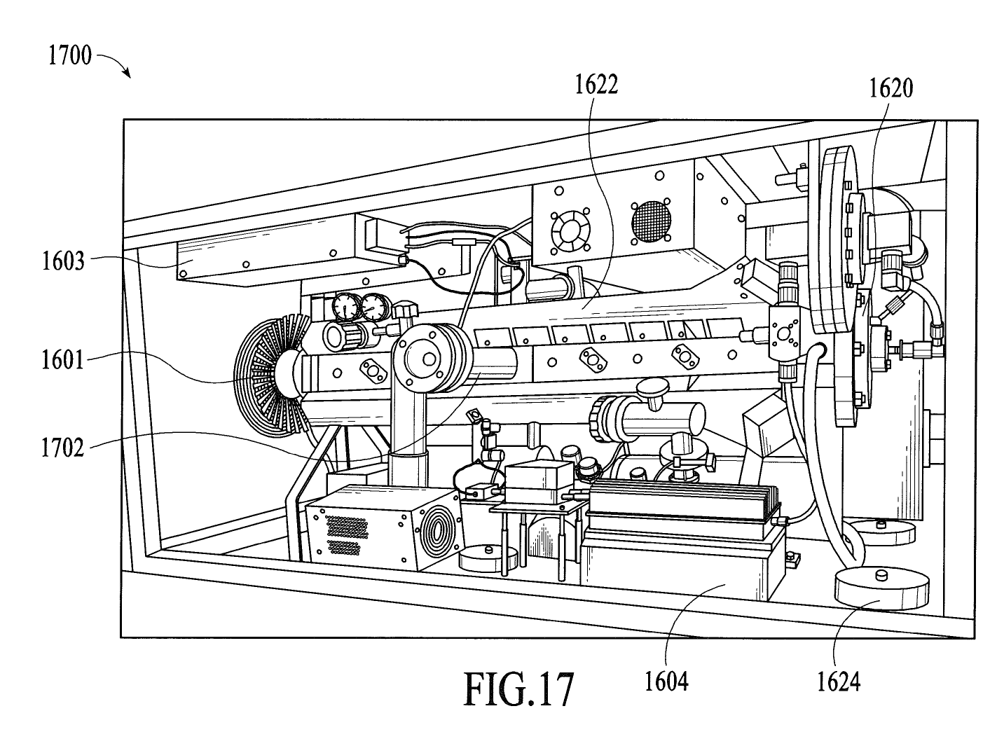

FIG. 17 illustrates a side view of the linear accelerator portion of the neutron generator of FIG. 16. The RFQ linac 1622 extends along the length of the generator assembly 1700 between the ion source 1620 and the target plate 1601. The 600 MHz RF power for the linac is input through pipe 1702, which contains the drive loop 900.

The portable neutron generator according to embodiments creates pure, low energy neutrons that are effective for detecting the presence of certain SNM. The neutron generator creates neutrons with energies on the order of 10 kV to 100 kV, with a median neutron energy of 60 kV. In general, a 60 kV neutron energy cannot cause fission in U238, which is ubiquitous, but it does cause fission in U235, which is rare. Therefore the low energy neutrons produced by the portable neutron generator are very useful in detecting the presence of U235, which is fissionable by these slow neutrons. The neutron generator under embodiments produces only low energy neutrons and no high energy neutrons. This eliminates the possibility of causing U238 fission, which might cause an excess of noise or interference during the attempted detection of U235.

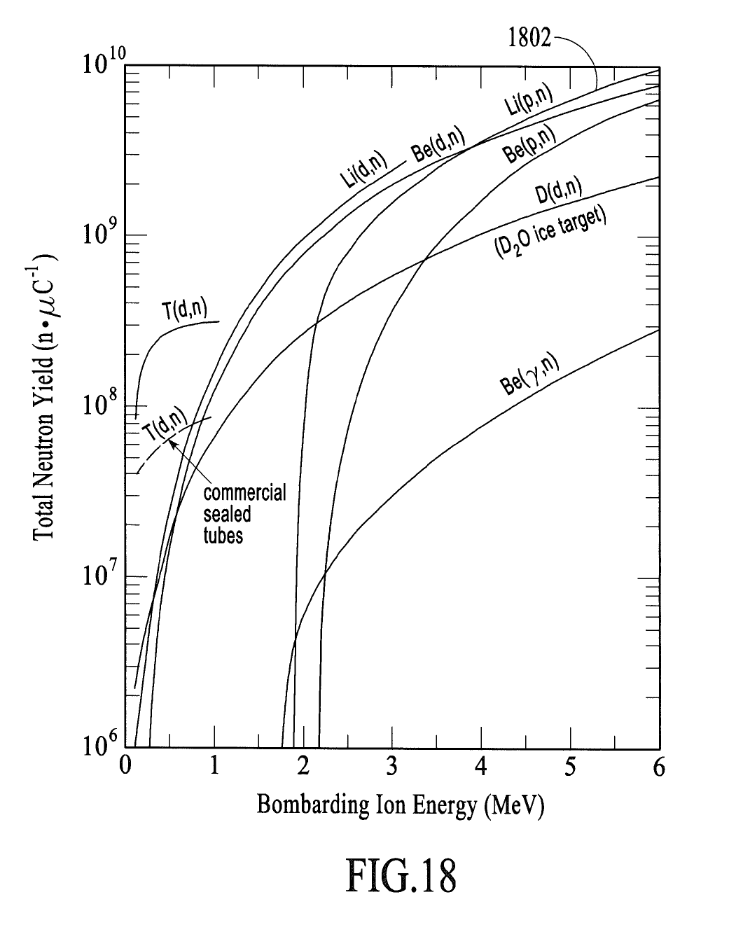

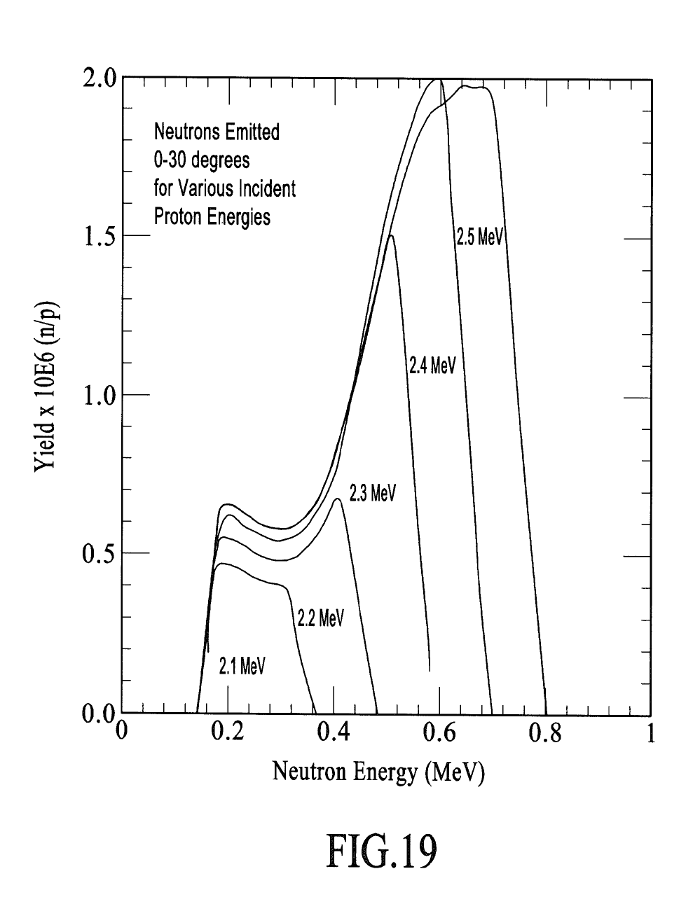

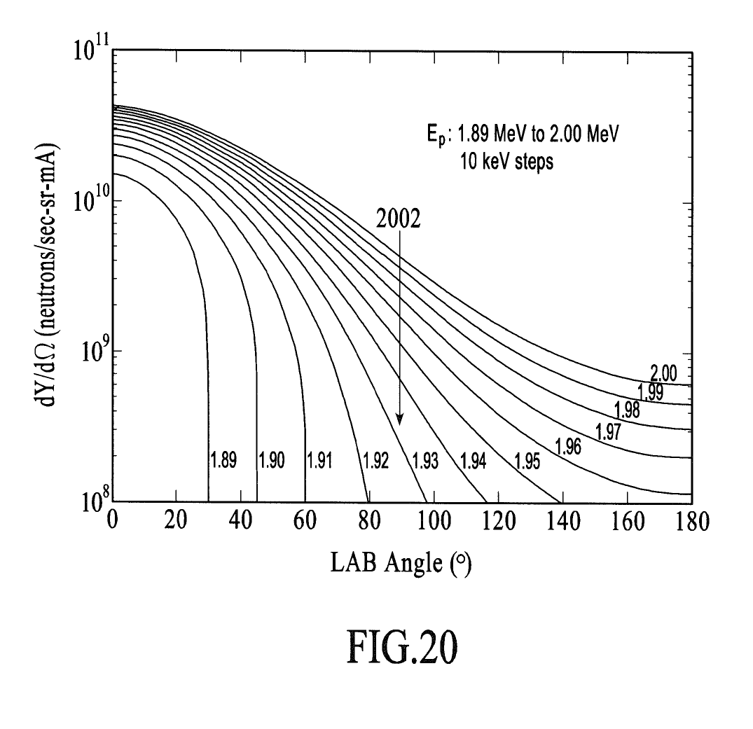

FIG. 18 is a graph illustrating neutron source yields using low energy nuclear reactions. As can be seen in FIG. 18, the neutron yield curve 1802 for Li(p,n) is nearly vertical compared to the other elements, thus the total neutron yield increases in the forward direction for a relatively constant bombarding on energy. FIG. 19 is a graph illustrating the neutron output energy for the ⁷Li(p,n) reaction. FIG. 20 is a graph illustrating neutron output angles for a ⁷Li(p,n) reaction. The neutron generator under an embodiment uses the 1.93 MeV curve 2002. This is set by the geometry of the linac. This energy curve gives low energy neutrons only and no high energy neutrons that may cause U238 fission.

Embodiments of the portable neutron generator described herein are suitable for detection and material characterization of SNM in the field. It is suitable for use by operators that may include border or traffic police, baggage handlers or freight companies.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While embodiments may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of producing neutrons, comprising:
bleeding hydrogen gas into a cavity through an opening at a first end, wherein said cavity further comprises an orifice at a second end and an antenna inside said cavity;
exciting said hydrogen gas with adjustable frequency RF power from an adjustable RF linear amplifier, wherein said frequency is adjusted to maximize the production of ionized protons within said cavity;
providing an electrostatic field across said cavity from said first end to said second end, wherein said first end is negative and said second end is positive, wherein ionized protons will drift in the direction of said second end and through said orifice, wherein an ion accelerator is operatively connected to said cavity to receive said ions as they pass through said orifice;
differentially vacuum pumping across said orifice, wherein the vacuum on the cavity side of said orifice is not as evacuated as the cavity on the accelerator side of said orifice;
accelerating said ionized protons with the voltage output of a solid state linear RF generator;
adjusting the frequency output of said solid state linear RF generator to maximize the number of accelerated protons; and
directing the accelerated protons onto lithium coated silver target to produce neutrons, wherein said target is thermally connected to radial cooling fins.

2. The method of claim 1, wherein the cavity comprises metal lined with ceramic insulating material.

3. The method of claim 1, further comprising providing a reasonably homogenous magnetic field along the cavity to make use of electron cyclotron resonance.

4. The method of claim 1, wherein the adjustable frequency RF power is provided by creating microwave power by a frequency synthesized signal, amplifying the microwave power through a set of power RF amplifiers, wherein the RF signal is decoupled from the ground potential by transferring the RF signal from a coaxial cable to a waveguide, wherein the RF wave penetrates an electrically insulating barrier and gets converted back to a now electrically floating RF signal.

5. The method of claim 4, wherein said frequency is adjusted by adjusting a magnetic field surrounding said cavity to compensate for changes in the magnetic field due to temperature by moving magnetic field creating permanent magnets closer to said cavity.

6. The method of claim 5, wherein said magnetic field creating permanent magnets are moved closer to said cavity by embedding permanent magnet rods in a plastic matrix which pushes the magnets inward when the temperature rises.

7. The method of claim 5, further comprising floating said cavity and its RF antenna at a positive high voltage potential, and accelerating said protons through an Einzel lens assembly into the input aperture of said accelerator

8. The method of claim 7, wherein said accelerator comprises a Radio-frequency Quadrupole (RFQ) accelerator.

9. The method of claim 8, wherein said RFQ accelerator a copper or silver coating.

10. The method of claim 1, wherein said solid state linear RF generator creates the needed RF microwave power at about 150 kW, 600 MHz

11. The method of claim 10, wherein said solid-state linear RF generator is liquid cooled.

12. The method of claim 1, wherein the step of adjusting the frequency output of said solid state linear RF generator comprises adjusting a quartz crystal stabilized frequency with the help of an automatic feedback to keep the frequency optimized when said accelerator cavity changes temperature, changing the resonant frequency of said cavity.

13. The method of claim 1, wherein said protons are accelerated to an energy of approximately 1930 keV to penetrate the protective coating of said target and to arrive at said target just above the nuclear reaction threshold of 1880 keV.

14. The method of claim 1, further comprising eliminating backward emitted neutrons from said target by kinematically focusing said neutrons in the forward direction.

15. The method of claim 1, further comprising eliminating the production of energetic neutrons.

16. The method of claim 1, wherein said target is thermally connected to radial cooling fins.

17. The method of claim 1, further comprising protecting the thin lithium target with a thin coating of oxygen tight material to prevent oxidation of the lithium and reducing the neutron output.

18. The method of claim 1, further comprising keeping the lithium target thin enough not to slow the protons inside the lithium to an energy of less than 500 keV.

19. A neutron source, comprising:
a cavity;
means for bleeding hydrogen gas into said cavity through an opening at a first end, wherein said cavity further comprises an orifice at a second end and an antenna inside said cavity;
an adjustable RF linear amplifier for exciting said hydrogen gas, wherein said frequency is adjusted to maximize the production of ionized protons within said cavity;
means for providing an electrostatic field across said cavity from said first end to said second end, wherein said first end is negative and said second end is positive, wherein ionized protons will drift in the direction of said second end and through said orifice, wherein an ion accelerator is operatively connected to said cavity to receive said ions as they pass through said orifice;
means for differentially vacuum pumping across said orifice, wherein the vacuum on the cavity side of said orifice is not as evacuated as the cavity on the accelerator side of said orifice;
a solid state linear RF generator to provide a voltage for accelerating said ionized protons;
means for adjusting the frequency output of said solid state linear RF generator to maximize the number of accelerated protons; and
a lithium coated silver target to produce neutrons, an means for directing said accelerated protons onto said target, wherein said target is thermally connected to radial cooling fins.

20. The method of claim 1, wherein the cavity comprises metal lined with ceramic insulating material.
